(19) United States
(12) Patent Application Publication
(10) Pub. No.: US 2019/0225524 A1
(43) Pub. Date: Jul. 25, 2019

(54) WASTE WATER SOLIDS SEPARATOR SYSTEM AND METHOD

(71) Applicant: VICTOR A. WEIR, II, Fort Worth, TX (US)

(72) Inventor: VICTOR A. WEIR, II, Fort Worth, TX (US)

(21) Appl. No.: 16/321,235

(22) PCT Filed: May 25, 2017
(86) PCT No.: PCT/US17/34451

§ 371 Date: Jan. 28, 2019

Related U.S. Application Data
(60) Provisional application No. 62/348,873, filed on Jun. 11, 2016.
(60) Provisional application No. 62/450,886, filed on Jan. 26, 2017.

(51) Int. Cl. C02F 11/127; C02F 11/18

(52) U.S. Cl. CPC C02F 11/127; C02F 11/185; C02F 2303/26; C02F 2301/08; C02F 2301/063

(57) ABSTRACT

A closed system and method for efficient separation, drying, pasteurization and disposal of water treatment facility sludge effluent substantially reduces its water content, and thereby its volume and weight. A separator directs influent sludge into hydrocyclones that spin the sludge, separating most of the water into an upper chamber and dropping the solids into a lower chamber surrounded by an oil bath shell which heats and denatures the solids. Forced air through a venturi creates a vacuum in the lower chamber, causing much of the remaining water to vaporize and drawing the solids out onto a conveyor. Another oil bath shell surrounding the conveyor further heats the solids, while heated air forced across the solids further dries them while evacuating the vapor. The resulting dried sludge cake contains as little as ten (10%) percent water, while the closed system deters escape of odors and corrosive vapors.

### BACKGROUND OF THE INVENTION

### 1. Field of the Invention

This invention relates generally to water treatment systems, and particularly to such systems for disposal of solid matter contained within raw water such as drinking water sources and sewage wastewater. More particularly, this invention relates to the volume, storage and transportation of such solid matter. Still more particularly, this invention relates to a system and method of effective drying of solid matter removed from water for subsequent disposal and/or use thereof as fertilizer or building materials.

### 2. Description of Related Art

A pressing need for every water treatment plant is separation of solids from usable water, whether raw intake water for potable water systems, or effluent from wastewater treatment facilities, as well as the safe disposal of the solids themselves. Wastewater in particular must be separated from solids prior to discharging the water back into streams and waterways. Potable water systems must remove debris and non-organic materials from lake bottoms and the like before treating the water and introducing it into potable water systems. Conventional systems skim, flocculate and otherwise capture usable water, but leave a solids portion that must be disposed of.

The solids portion, also commonly referred to as “sludge”, contains from 2%-5% solid matter of various compositions, the remainder being water. It is too polluted to dump into the streams and waterways, at least under modem regulatory rules, and the traditional solution has been to pump it into drying beds to let the water evaporate, leaving a layer of dried solids in situ. This method, however, contaminates extensive real estate, is vulnerable to runoff into streams and waterways due to precipitation, and, particularly for wastewater sludge, can be a source of objectionable odors when located near populated areas. As a result, recent regulatory rules prevent using this method in most cases.

As de-watered solids from wastewater sludge usually can contain significant organic nutrients, they have become attractive as fertilizer for farms and gardens. Potable water treatment sludge by contrast, usually contains mostly inorganic materials (e.g. sand) which can be useful as road building materials. Methods to de-water the solids include mechanical and centrifugal presses, which reduce the sludge into a “cake” similar to damp earth but which still contains only 18%-3% solids. Because it remains mostly water, transportation and storage thereof can be very expensive.

Various types of further drying methods have developed to mitigate this problem. Some have succeeded in reducing the resulting cake to between 10%-20% water, greatly reducing the weight and volume of the cake and the concomitant costs of handling it. Such methods involve significant investments in capital equipment and real estate, however, and many if not most legacy water treatment facilities cannot afford such investments or don't have the room to provide them. A need exists for low-cost, spatially compact drying methods for de-watering sludge cake prior to it leaving such water treatment facilities.

Most countries also strictly regulate methods for killing pathogens in sewage and methods for disposal of the wastewater solids so treated. Two basic options exist: chemical treatment and pasteurization. In chemical treatment, lime or other chemicals may be mixed into the cake to kill harmful pathogens, but some chemicals can render the cake useless as fertilizer. Pasteurization employs heat to evaporate the water and to kill pathogens, but it usually is very energy intensive and therefore costly. A need exists for efficient, low cost de-watering and pasteurization of sewage wastewater sludge cake.

### SUMMARY OF THE INVENTION

A closed system and method for efficient separation, drying, pasteurization and disposal of water treatment facility sludge effluent substantially reduces its water content, and thereby its volume and weight. A separator directs influent sludge into hydrocyclones that spin the sludge, separating most of the water into an upper chamber and dropping the solids into a lower chamber surrounded by an oil bath shell which heats and denatures the solids. Forced air through a venturi creates a vacuum in the lower chamber, causing much of the remaining water to vaporize and drawing the solids out onto a conveyor. Another oil bath shell surrounding the conveyor further heats the solids, while heated air forced across the solids further dries them while evacuating the vapor. The resulting dried sludge cake contains as little as ten (10%) percent water, while the closed system deters escape of odors and corrosive vapors.

### BRIEF DESCRIPTION OF THE DRAWINGS

The novel features believed characteristic of the present invention are set forth in appended claims. The invention itself, as well as a preferred mode of use and further objects and advantages thereof, will best be understood by reference to the following detailed description of an illustrative embodiment when read in conjunction with the accompanying drawings, wherein:

FIG. 1 illustrates a schematic of the sludge cake de-watering system of the present invention.

FIG. 2 shows in vertical elevation section view, taken as indicated in FIG. 3, a de-watering manifold for use with the present invention.

FIG. 3 shows in horizontal plan view, taken as indicated in FIG. 2, the manifold of FIG. 2.

FIG. 4 details in horizontal plan view a segment of a screw conveyor for use with the present invention.

FIGS. 5 shows in vertical elevational view a section through the screw conveyor of FIG. 4.

FIG. 6 details the steps in the process of de-watering and drying sewage sludge into fertilizer using the present invention.

### DESCRIPTION OF PREFERRED EMBODIMENT

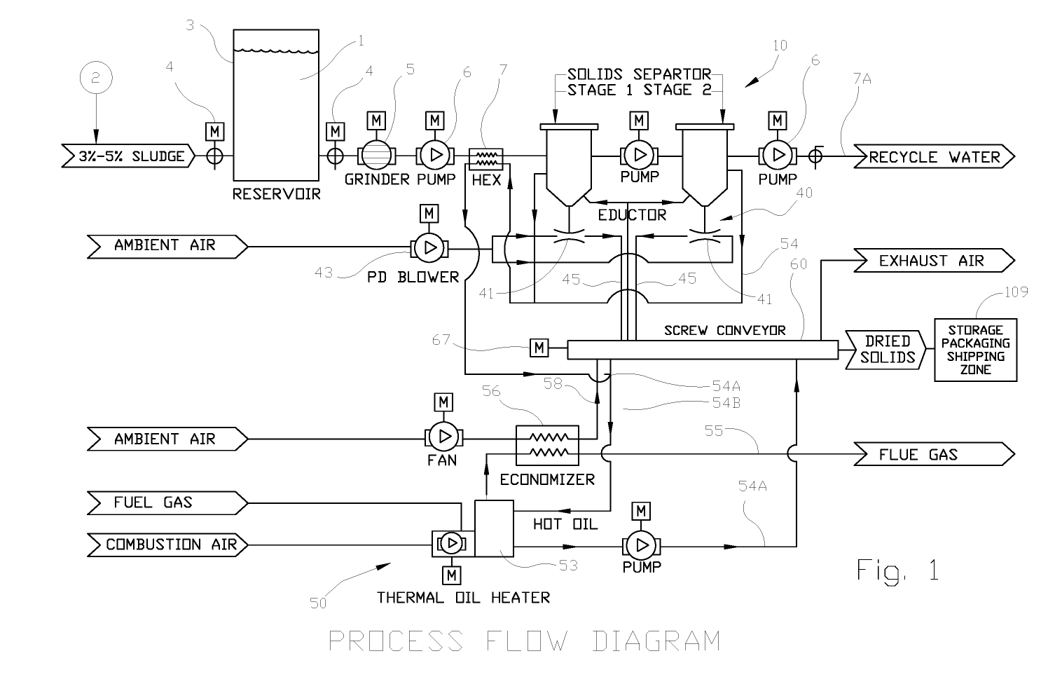

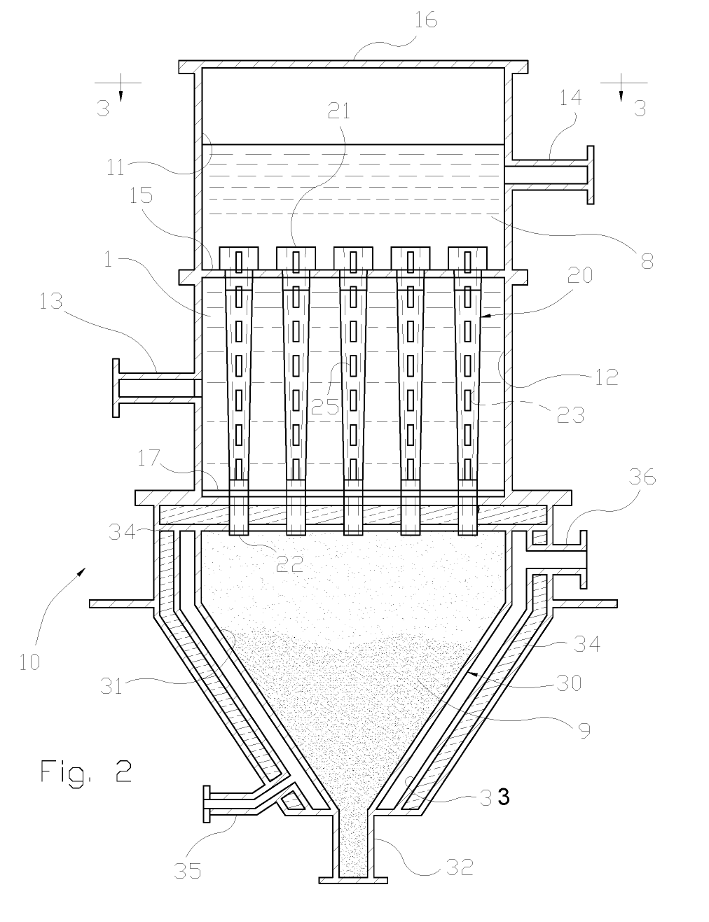

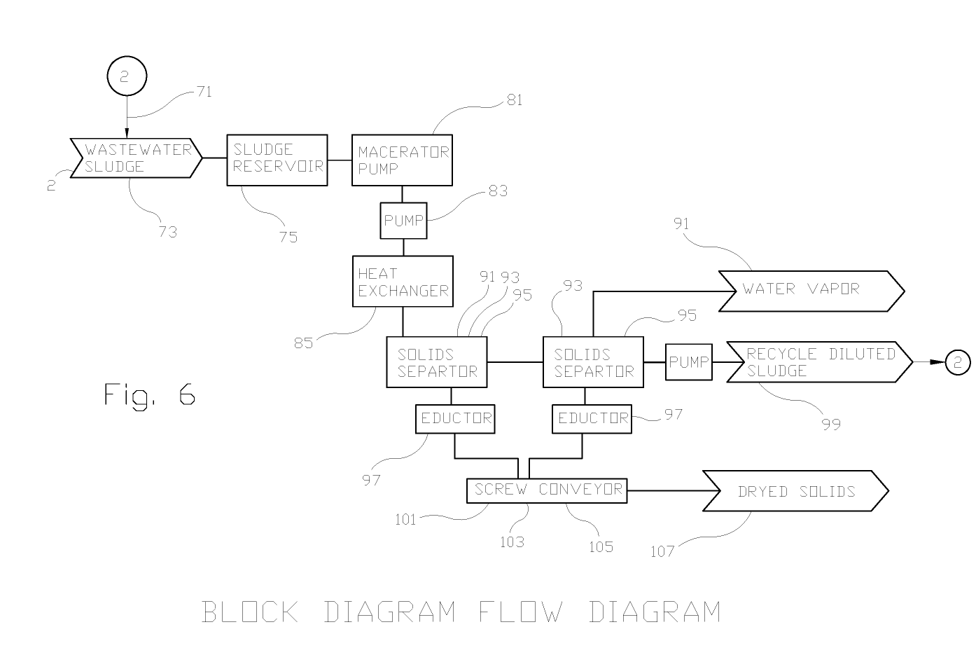

Referring now to the figures, and particularly to FIG. 1, the present invention shown in schematic form includes one or more solids separators 10 which removes most of the water from influent, treated sludge 1 and discharges 7A it therefrom for further recycling or disposal (neither shown). Sludge intake and preparation means consist of holding tank, or reservoir, 3 which receives sludge 1 from a sewage treatment plant (not shown) and provides a steady feed of sludge 1 into separators 10, valves 4 which control movement of sludge 1 into and out of reservoir 3, grinder 5 which assures that sludge 1 contains solids of a limited size, pump 6 which pressurizes sludge 1 and moves it into separators 10, and optional heat exchanger 7 which may pre-heat sludge 1. Blower 43 impels ambient air through venturi 41 to lower the pressure inside separators 10 and to assist in drawing separated sludge cake 9 out of separators 10. Sludge cake 9 exits mouth 32 (FIG. 2) which feeds it into screw conveyor 60 for further drying. Separated effluent water 8 (FIG. 2) likely still contains enough solids in suspension that it must be disposed of separately or returned (step 99 of FIG. 6) by way of lines 7A to water treatment plant 2 for further processing therein.

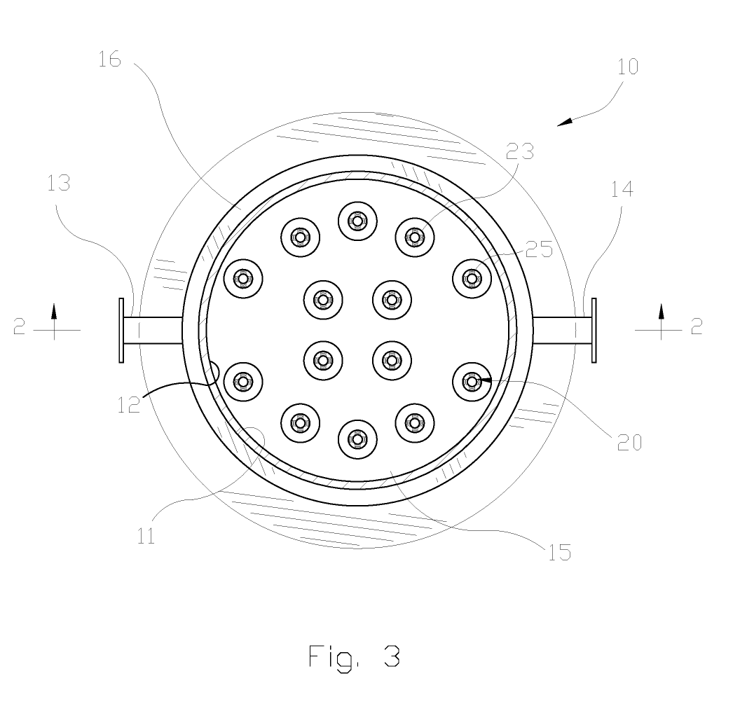

Turning now also to FIGS. 2-3, each separator 10 further comprises a middle chamber forming an intake manifold 12 into which influent sludge 1 flows through intake 13. Effluent recycle water 8 exits manifold 12 into an upper chamber serving as an outfall tank 11 which accumulates water separated from sludge 1 and discharges it through outlet 14 into lines 7A, while de-watered sludge cake 9 drops into lower chamber, or hopper 30, as described below. Baffle 15 separates upper outfall tank 11 from middle intake manifold 12, which itself is separated by floor, or bulkhead, 17 from hopper 30. Removable lid 16 provides access to upper tank 11 for maintenance and replacement of components there within.

Supported by their heads 21 on baffle 15, a plurality of cyclones 20 separate sludge cake 9 from recycle water 8, Cyclones 20 comprise elongate, substantially conical tubes having a vertically disposed cyclone axis extending between heads 21 and smaller nozzles 22 which extend through bulkhead 17 and into hopper 30. Pressurized by pump 6, sludge 1 enters swirl chambers 23 through a plurality of apertures 25 disposed along cyclones 20 under relatively even hydraulic pressure. This pressure differential along the axis of cyclones 20 causes sludge 1 to rotate inside swirl chambers 23, separating water 8 and propelling it upward through heads 21 and into upper chamber 11 while solids 9 precipitate and fall downward, through nozzles 22 and into hopper 30.

The size and number of cyclones 20 determine the gallons-per-minute (GPM) throughput of each separator 10, the number and size thereof being selected as needed for each installation. Baffle 15 preferably is fabricated with a plurality of ports for cyclones 20, not all of which may be needed for a given installation. A plug (not shown) can be provided to seal up any unused cyclone 20 ports (not shown), thereby maintaining a pressure and water tight barrier between upper outfall tank 11 and middle intake manifold 12.

A suitable cyclone 20 is available in one- to three-inch (1-3″) diameter specialty hydrocyclones from FLSmidth Krebs of Tucson, Ariz. USA. Pump 6 preferably induces forty to eighty (40-80) pounds per square inch gauge (PSIG) of pressure into the sludge. A suitable pump 6 is available as Compact C pump from Moyno Company of Springfield, Ohio USA.

As best seen in FIG. 6, an optional heat exchanger 7 (see also FIG. 6, step 85) may be included downstream of grinder/macerator 5 to preheat influent sludge 1 prior to its entry into separator 10. Preferably, heat exchanger 7 comprises a single pass device having a plurality of tube-within-a-tube segments (not shown) interconnected end to end to cause hot oil in an outer shell to surround and heat sludge flowing through the inner shell. Still more preferably, heat exchanger 7 provides hot oil counter flow whereby oil enters heat exchanger 7 near its outfall, thereby optimizing heat transfer into sludge 1.

In combination with elevated water pressure induced by pump 6, heated sludge 1 contains enough energy that, when separated solids 9 drop into hopper 30 from cyclones 20, much of the water remaining within solids 9 is released into the upper portion of hopper 30 in the form of water vapor. This “flash” evaporation effect occurs partly because the vacuum inside hopper 30 reduces the temperature at which water vaporizes, and partly because solids 9 are elevated in temperature from heat exchanger 7. The water vapor proceeds through the system as described below and may be captured (not shown) in vapor form for use in other processes (e.g. in heat exchangers) or safely discharged into the atmosphere.

Hopper 30 comprises an upper interior portion which substantially matches the horizontal shape and size of intake manifold 12 but which is disposed above and in fluid communication with a lower, conical-shaped bottom, or funnel 31, which terminates at its lowest extent in mouth 32 juxtaposed to eductor 40 (not shown in FIG. 2; see FIG. 1). Surrounding hopper 30 on all sides, hot oil shell 33 conducts hot oil from oil system 50, discussed below, through oil inlet 35 and oil outlet 36, to heat sludge cake 9 within hopper 30. This heating process both partially pasteurizes cake 9 and removes more water from cake 9 in the form of water vapor, as described above. Insulation 34 surrounds hot oil shell 33 to mitigate heat loss from hopper 30.

As best seen in FIG. 1, and discussed above, sludge cake 9 exits hopper 30 through eductor 40, drawn therefrom by gravity and by high speed ambient air forced through venturi 41 by positive displacement (PD) blower 43. A suitable venturi eductor 41 is available as Fox Solids-conveying Venturi Eductor from Fox Venturi Products of Dover, N.J. USA. A suitable PD blower 43 is available as Universal/RAI from Dresser Roots Company (Agent: PD Blowers, Inc. of Gainesville, Ga.) USA. Preferably, sludge cake 9 falls directly onto one of a plurality of conveyors, such as screw conveyor 60, by gravity feed. One having ordinary skill in the art will recognize, however, that any means to move cake 9 from the outfall of venturi 41 onto conveyor 60 is considered to be within the spirit and scope of the present invention.

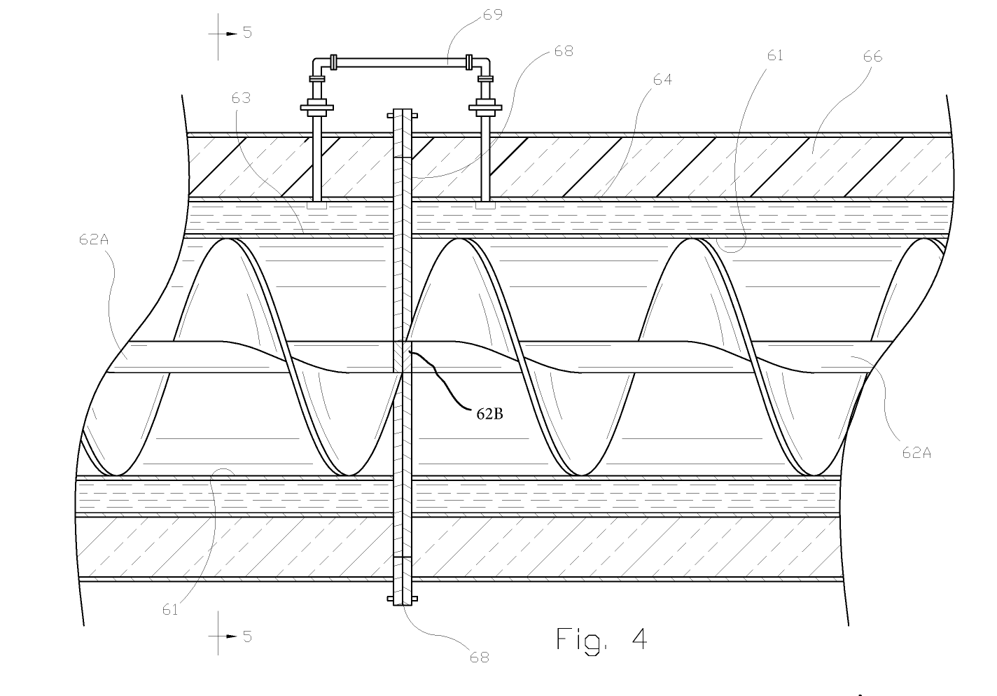

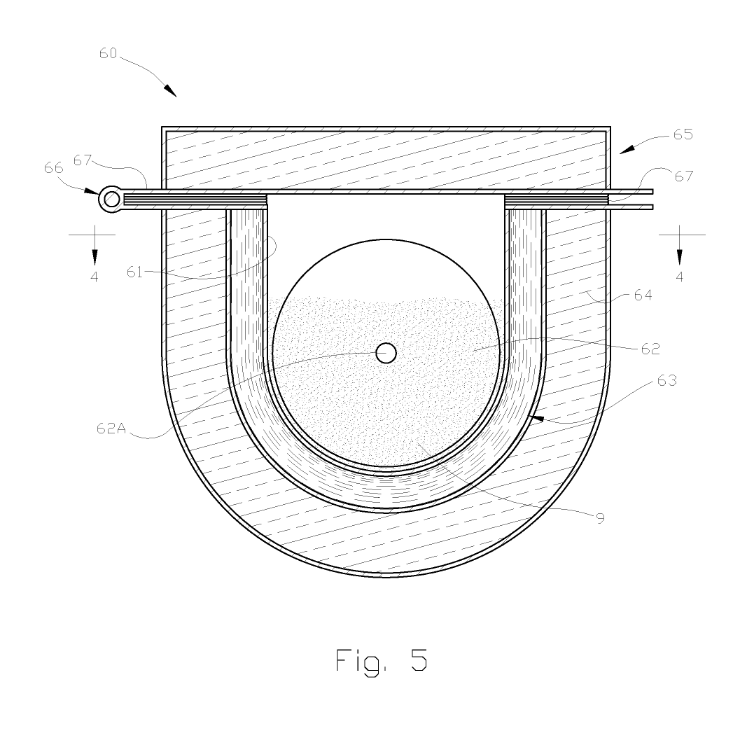

Turning now also to FIGS. 4 and 5, each conveyor 60 comprises a plurality of elongate, U-shaped, substantially horizontally disposed, conveyor channel 61 segments bolted end-to-end by their mating flanges 68. Each channel 61 surrounds an Archimedes screw journaled there within and turned about substantially horizontal axle 62A coaxial with channel 61, the axles 62A also coupled together between segments of conveyor 60 by flanges 62B to permit a single motor drive 67 (FIG. 1) to rotate all segments within a given conveyor 60.

As with hopper 30, channel 61 is surrounded, but only on three sides, by conveyor hot oil chamber 63 which preferably extends the full length of channel 61. Bypass oil connection means 69 links each oil chamber 63 to permit flow of hot oil from supply lines 54A through chambers 63 and eventually back to its source through return lines 54B. Top 65 disposed above screw 62 opens by hinge 66 to provide access to channel 61, preferably for its full horizontal length. Insulation layer 64 surrounds channel 61 on all sides, including top 65, further to conserve energy and minimize heat loss.

As shown in FIG. 1, hot oil for heat exchanger 7, hopper 30 and conveyor 60 is provided by thermal oil heater 51 coupled through oil reservoir 53 to hopper 30 and conveyors 60 by supply lines 54A and return lines 54B. Preferably, heater 51 employs fuel gas in a combustion chamber to heat the oil, the resulting flue gas being vented through flue gas disposal lines 55. A suitable heater 51 is available as catalog number HC-2 from Sigma Thermal Company of Marietta, Ga. USA. One having ordinary skill in the art will recognize, however, that any means of heating the oil passing through lines 54A, 54B is considered to fall within the spirit and scope of the present invention.

As best seen in FIG. 5, screw 62 does not entirely fill channel 61 within conveyor 60. Instead, an upper region, or air space 61A, of channel 61 is disposed between screw 62 and top 65. Further, air space 61A is not filled with sludge cake 9, as cake 9 lies at the bottom of channel 61 surrounding and impelled by screw 62. As shown in FIG. 1, blower 57 impels ambient air through economizer 56 and through air line 58 to conveyor 60. Air line 58 couples to air space 61A within channel 61, thereby passing the air through the length of channel 61 and across sludge cake 9, further to dry sludge cake 9 within conveyor 60. A suitable blower 57 is available as CPS-5 Utility Vent Set from Loren Cook Company of Springfield, Miss. USA.

Economizer 56 comprises a heat exchanger wherein flue gas from thermal oil heater 51 circulates along with ambient air from pump 57 to heat the latter on its way to conveyor 60. Thus, the air passing over sludge cake 9 within conveyor 60 is preheated, thereby further yet drying cake 9 as it moves through conveyor 60. A suitable economizer 56 is a flue gas-to-ambient heater available from Sigma Thermal Company of Marietta, Ga. USA. One having ordinary skill in the art will recognize that economizer 56 is an option, and may or may not be included. When it is included, heat used to preheat this ambient air is recaptured from the combustion gasses of oil heater 51, lending further energy efficiencies to the system.

Turning now again to FIG. 6, in operation, raw water, whether river and lake water or sewage and/or industrial waste (neither shown) is treated 71 in separate water treatment plant 2, sludge 1 being continuously fed therefrom into reservoir 3 as discussed above. At this stage, treated sludge 1 contains approximately three- to five- (3-5%) percent solids, the rest being water. From reservoir 3, sludge 1 proceeds to grinder, or macerator 5, where any large particles remaining in sludge 1 are reduced in size 81 so that they pass smoothly through apertures 25 of cyclones 20 within separator 10. A suitable macerator 5 is available as the “EZstrip TR Muncher” from Moyno Company of Springfield, Ohio USA.

Sludge 1 effluent from macerator 5 then is pressurized by pump 6 to approximately 40-80 PSIG and optionally passed through heat exchanger 7 (step 85 of FIG. 6) to preheat sludge 1 to a temperature of 180-200 degrees Fahrenheit prior to entering separator 10 through inlet 13. Pressurizing sludge 1 forces it through apertures 25 within cyclones 20, causing it to swirl therein and solids 9 to precipitate 93 out of suspension, thereby de-watering 93 solids 9 as they drop into hopper 30. Separated liquid water 8 within upper outfall tank 11 is recycled 99 to water treatment plant 2.

Within hopper 30, the combined vacuum induced by eductor 40 and the preheating by heat exchanger 7 causes most of the water remaining within solids 9 to flash into water vapor, even further de-watering solids 9. Now appropriately referred to as sludge “cake”, solids 9 are further heated 95 by the hot oil circulating within shell 33 to a temperature of approximately 220-250 degrees Fahrenheit. This not only further dries sludge cake 9, but also performs a pasteurizing step to denature cake 9 and to kill pathogens therein which may have escaped the water treatment plant. Sludge cake 9 typically remains inside hopper 30 for one to two (1-2 min.) minutes as it proceeds toward mouth 32 and venturi 41.

Drawn 97 from hopper 30 under lowered pressure from venturi 41, sludge cake 9 drops via gravity feed into chamber 61 of conveyor 60 and is impelled 101 toward storage, packaging and shipping facilities (not shown) beyond the outfall end of conveyor 60. Cake 9 is further heated, both by hot oil 103 within conveyor hot oil chamber 63 and by the preheated air 105 from economizer 56, to an average temperature of 220-250 degrees Fahrenheit, where it remains for five to ten minutes while propagating through conveyor 60. Sludge cake 9 exits conveyor 60 at a dried solids storage or packaging zone juxtaposed to said separator system and preferably adjacent said sewage treatment plant. Al said solids storage and packaging zone, sludge cake 9 then may be air cooled 107, optionally packaged and transported and stored for use as a fertilizer or construction material.

Thus, by the time sludge cake 9 exits conveyor 60, it is reduced to as little as ten (10%) percent water and its weight is reduced to approximately fifty to sixty (50-60 pcf) pounds per cubic foot, making it far more economical to transport and store than influent treated sludge 1. Further, it has been pasturized by the heating processes to kill residual pathogens susceptible to heat denaturing, making cake 9 not only safer and more sanitary, but also likely to smell less unpleasant that the normal sludge 1 effluent from water treatment plants. Finally, output sludge cake 9 treated with the present invention turns a waste disposal problem from the water treatment process into a useful byproduct for agricultural and construction applications, providing municipalities with a much needed revenue source.

A significant advantage of the present invention is that it is a closed system, as opposed to alternatives such as drying beds or belt press dryers, which are open systems. This means that sludge 1 and cake 9 remain entirely within the system and are not allowed to emit odors or corrosive vapors, as with belt press dryers and other open systems.

While the invention has been particularly shown and described with reference to preferred and alternate embodiments, it will be understood by those skilled in the art that various changes in form and detail may be made therein without departing from the spirit and scope of the invention. For example waste heat in the form of steam (water vapor) may be used as a free energy source and bio-gas as a byproduct fuel from plants utilizing anaerobic digestion of sludge.

Also, conveyor 60 has been discussed above as incorporating screw 62 to move cake 9 thorough its interior. Instead, screw 62 could be replaced with other solids 9 movement means, such as a conveyor (not shown).

In another embodiment, upper chamber 11 and middle chamber 12 may be replaced with a dry manifold (not shown) having a plurality of individual hydrocyclones which individually are fed with sludge 1 and pipe effluent water 8 back to treatment plant 2 while dropping solids 9 directly into hopper 30 to be heated and passed along to conveyor 60 as described above.

Such dry manifold and/or individual cyclones may or may not include a heating jacket and/or insulation surrounding each to conserve and/or add additional heat to sludge 1 and/or solids 9 prior to entering hopper 30. This may depend upon the nature of solids 9 and whether or not they need to go through the flash evaporation step within hopper 30. Inorganic solids, usually found in effluent sludge from raw potable water treatment systems, are higher in specific gravity than organic solids found in wastewater sludge. Such inorganic solids thus fall faster to the bottom of hopper 30 and retain less water than wastewater sludge, and may not require the flash evaporation step.

1. A wastewater solids separator system comprising
intake means for receiving and preparing influent wastewater sludge;
separator means for separating said wastewater sludge into effluent water and sludge cake;
conveyor means for conveying said sludge cake away from said separator; and
drying means for further drying and de-watering said sludge cake.

2. The wastewater solids separator system of claim 1 wherein said intake means comprises
a reservoir adapted to accumulate wastewater sludge;
a grinder coupled downstream of the reservoir and adapted to grind solids within said wastewater sludge;
a pressurizer pump coupled downstream of said grinder and adapted to pressurize said wastewater sludge and to impel it into said separator means.

3. The wastewater solids separator system of claim 2 and further comprising
a heat exchanger coupled downstream of said grinder and adapted to preheat said wastewater sludge.

4. The wastewater solids separator system of claim 3 wherein said heat exchanger comprises
an outer shell coupled between said grinder and said separator and adapted to contain hot oil flowing through said outer shell;
a plurality of inner tubes surrounded by said outer shell, each tube having a grinder end and a separator end and adapted to transmit wastewater sludge flowing through said heat exchanger.

5. The wastewater solids separator system of claim 4 wherein
said hot oil flows through said outer shell in a direction counter to the direction of flow of said wastewater sludge.

6. The wastewater solids separator system of claim 1 wherein said separator means comprises
a manifold coupled to said intake means and adapted to receive said wastewater sludge from said intake means;
cyclone means disposed within said manifold for cyclonically swirling said wastewater sludge and to cause
solid materials within said wastewater sludge to precipitate downward and to form said sludge cake; and
said effluent water to migrate upward and out of said cyclone means;
a tank coupled to said cyclone means and adapted to receive said effluent water; and
a hopper coupled to said cyclone means for receiving said sludge cake.

7. The wastewater solids separator system of claim 6 wherein
said tank is coupled to said manifold by a baffle;
said cyclone means is in fluid communication between said manifold and said tank through said baffle;
said hopper is coupled to said manifold by a bulkhead; and
said cyclone means is in fluid communication between said manifold and said hopper means through said baffle.

8. The wastewater solids separator system of claim 6 wherein said cyclone means comprises
at least one conical tube having
a vertical tube axis extending between an upper large tube end in fluid communication with said tank and a lower small tube end in fluid communication with said hopper;
tube walls coaxial with said vertical axis and surrounding and defining a conical shaped tube interior, said tube walls surrounding and defining a plurality of apertures disposed along said longitudinal axis and in fluid communication between said manifold and said tube interior.

9. The wastewater solids separator system of claim 6 wherein said hopper further comprises
a vertical hopper axis;
hopper walls surrounding said vertical hopper axis and defining
an upper interior hopper region in fluid communication with said cyclone means; and
a lower interior hopper region coupled below said upper interior hopper region and tapering away from said upper interior hopper region and converging to a mouth coupled to said conveyor means; and
eductor means coupled to said mouth and adapted to lower pressure within said hopper.

10. The wastewater solids separator system of claim 9 wherein said eductor means comprises
an ambient air source;
a blower coupled to said ambient air source and adapted to force air from said ambient air source into an air duct; and
a venturi disposed within said air duct adjacent to said mouth and in fluid communication with said lower hopper region.

11. The wastewater solids separator system of claim 9 wherein said hopper further comprises
a hot oil shell at least partially surrounding said hopper walls and defining a hot oil shell interior juxtaposed to said hopper walls and in thermal communication with at least one of said upper interior hopper region and said lower interior hopper region, said hot oil shell having an oil inlet and an oil outlet adapted to transmit hot oil flowing through said hot oil shell interior.

12. The wastewater solids separator system of claim 1 wherein said conveyor means comprises
a conveyor channel coupled to said separator means, said conveyor channel having
a longitudinal conveyor channel axis extending between a conveyor channel intake coupled to said separator means and an opposite conveyor channel outfall; and
an Archimedes screw disposed within said conveyor channel and adapted to impel said sludge cake through said conveyor channel along said conveyor channel axis.

13. The wastewater solids separator system of claim 12 wherein said conveyor channel further comprises
a substantially U-shaped trough having
a trough bottom surrounding and defining a lower trough interior coaxial with said Archimedes screw, said lower trough interior adapted to contain said sludge cake; and
trough side walls extending upward from said trough bottom on either side of said longitudinal axis to form an air space above and in fluid communication with said lower trough interior for at least a portion of said longitudinal axis; and
a blower coupled to said air space and adapted to blow ambient air across said sludge cake within said U-shaped trough.

14. The wastewater solids separator system of claim 13 wherein said conveyor means comprises
a plurality of said conveyor channels coupled end to end to create a conveyor of a select length; and
said Archimedes screw comprises a plurality of segments of Archimedes screws coupled end-to-end within said U-shaped troughs.

15. The wastewater solids separator system of claim 13 and further comprising
a hot oil chamber juxtaposed to and in thermal communication with said trough bottom and said trough sides, said hot oil chamber having a hot oil inlet and a hot oil outlet and adapted to transmit hot oil flowing through said hot oil chamber to heat said lower trough interior and said air space.

16. The wastewater solids separator system of claim 14 wherein
each of said conveyor channels of said plurality of conveyor channels further comprises
a hot oil chamber at least partially surrounding said trough bottom and said trough sides, and
a hot oil inlet and a hot oil outlet coupled to opposite ends of said hot oil chamber;
and said conveyor means further includes
a bypass connector coupled between said hot oil chamber outlet of one of said conveyor channels and said hot oil inlet of an adjacent conveyor channel
whereby said hot oil channels of adjacent conveyor channels are in fluid communication with each other, and whereby said hot oil flows through said select length of said conveyor.

17. A wastewater solids separator system for separating solids from wastewater sludge, the wastewater solids separator system comprising
a separator having
a manifold adapted to receive said wastewater sludge;
at least one cyclone disposed within said manifold for cyclonically swirling said wastewater sludge and precipitating solids downward to form sludge cake and migrating effluent water upward and out of said cyclone;
a tank coupled to said cyclone adapted to receive said effluent water;
a hopper coupled to said cyclone for receiving said sludge cake;
a hot oil shell surrounding at least one portion of said hopper and adapted to heat an interior of said hopper and said sludge cake; and
an eductor coupled to said hopper and adapted to lower air pressure within said hopper and to cause
water vapor to evaporate from said sludge cake; and
said sludge cake to exit said hopper;
a sludge cake conveyor coupled downstream of said eductor and having
a longitudinal, U-shaped conveyor channel surrounding and defining a lower conveyor channel interior;
an Archimedes screw disposed within said conveyor channel and adapted to impel said sludge cake through said conveyor channel along said conveyor channel axis;
a hot oil chamber surrounding a substantial portion of said conveyor channel and adapted to heat an interior of said conveyor channel containing said sludge cake;
said conveyor channel forming an air space above said Archimedes screw and said sludge cake and extending substantially a length of said interior of said conveyor channel; and
a blower coupled to said air space and adapted to force ambient air across said sludge cake within said conveyor channel.

18-24. (canceled)

25. An improved method of separating and drying sludge cake contained in wastewater sludge, the improved method comprising the steps of
providing a wastewater sludge cake separator having
a manifold adapted to receive said wastewater sludge from a wastewater sewage system;
cyclone means disposed within said manifold for cyclonically swirling said wastewater sludge to separate said wastewater sludge into sludge cake and effluent water;
a tank coupled to said cyclone means and adapted to receive said effluent water; and
a hopper coupled to said cyclone means for receiving said sludge cake;
providing a conveyor coupled to said hopper, said conveyor having
a longitudinal conveyor axis; and
an Archimedes screw disposed within said conveyor and adapted to impel said sludge cake through said conveyor along said conveyor axis; and
providing drying means for drying said sludge cake; then
pressurizing said wastewater sludge using a pressurizing pump; then
feeding said pressurized wastewater sludge into said manifold; then
drying said sludge cake after it is separated from said effluent water by said cyclone means;
operating said conveyor to move said sludge cake from said hopper toward a zone adapted for storage, packaging and shipping said sludge cake.

26, 28, 30-31. (canceled)

27. The improved method of claim 25 wherein
said providing drying means step further comprises the steps of
providing a forced air duct having a venturi coupled to said hopper;
providing a hot oil shell surrounding at least a portion of said hopper; and
providing a thermal oil heater coupled to said hot oil shell; and
said drying step further comprises the steps of
impelling ambient air through said forced air duct and venturi to reduce pressure inside said hopper and to cause water to flash evaporate from said sludge cake as it enters said hopper; and
generating hot oil with said thermal oil heater and directing said hot oil into said hot oil shell, thereby to heat and further dry said sludge cake while it is within said hopper.

29. The improved method of claim 25 wherein drying step comprises the additional steps of:
said providing drying means comprises
providing a hot oil chamber surrounding at least a portion of said conveyor;
providing a thermal heater coupled to said hot oil chamber;
providing an air space within conveyor above said Archimedes screw;
said drying step further comprises the steps of
generating hot oil with said thermal oil heater and directing it through said hot oil chamber to heat and further dry said sludge cake as it propagates through said conveyor; and
impelling ambient air through said air space within said conveyor to carry away water vapor and heat from said sludge cake as said sludge cake propagates through said conveyor.
